(19) United States
(12) Patent Application Publication
(10) Pub. No.: US 2010/0173744 A1
(43) Pub. Date: Jul. 8, 2010

(54) METHOD AND DEVICE FOR OPERATING A DRIVE UNIT

(76) Inventor: Andreas Seel, Bonn (DE)

Correspondence Address: KENYON & KENYON LLP, ONE BROADWAY, NEW YORK, NY, 10004, US

(21) Appl. No.: 12/593,609

(22) PCT Filed: Mar. 11, 2008
(86) PCT No.: PCT/EP08/52877

§ 371 Date: Mar. 9, 2010

(30) Foreign Application Priority Data
Mar. 27, 2007 (DE) 10 2007 014 500.6

(51) Int. Cl. B60W 20/00; B60W 10/06; B60W 10/08; B60L 11/02

(52) U.S. Cl. 477/3; 903/902; 180/65.265

(57) ABSTRACT

A method and an apparatus are provided for operating a drive unit having at least one combustion engine and at least one electrical machine mechanically coupled to the at least one combustion engine. The method and apparatus enable improved boost operation. In an embodiment, a target value for an output variable of the drive unit is implemented by the at least one combustion engine and the at least one electrical machine. The contribution of the at least one electrical machine to the implementation of the target value for the output variable is made available at most for a predefined time.

### FIELD OF THE INVENTION

The present invention related to a method and an apparatus for operating a drive unit.

### BACKGROUND INFORMATION

Methods and apparatuses for operating a drive unit having at least one combustion engine and at least one electrical machine mechanically coupled to the at least one combustion engine, a target value for a torque of the drive unit being implemented by the at least one combustion engine and the at least one electrical machine, may be available. German patent reference no. DE 10 2004 044 507 A1, for example, apparently discloses a method for operating a vehicle drive system having at least one combustion engine and at least one electrical machine mechanically coupled to the at least one combustion engine, and having an energy reservoir operatively connected to the electrical machine and/or the combustion engine.

### SUMMARY OF INVENTION

Embodiments of the present invention provide a method and an apparatus for operating a drive unit, in which the contribution of the at least one electrical machine to implementation of the target value for the output variable is made available at most for a predefined time. Thus, for example, when the predefined time is selected appropriately, one can prevent an undesirably severe discharge of the energy reservoir as a result of the contribution of the at least one electrical machine for implementation of the target value for the output variable of the drive unit. Otherwise, the energy reservoir might become too greatly discharged, with the result that the energy reservoir would be damaged and the functionality of the drive unit would be limited.

Embodiments of the present invention provide for reducing the contribution of the at least one electrical machine to the implementation of the target value for the output variable either upon expiration of the time for which the target value is predefined or after expiration of the predefined time, depending on which of the two times expires earlier. This ensures, for example, by way of a simple minimum-value selection, that the contribution of the at least one electrical machine to implementation of the target value for the output variable is made available for no longer than the predefined time.

In embodiments of the present invention, most simply and with the least possible outlay, the predefined time can be predefined as a fixed value. This fixed value can be suitably applied, for example, on a test stand in order reliably to prevent an undesirably severe discharge of the energy reservoir. In an embodiment, the smaller the fixed value selected for the predefined time, the more reliably an undesirably severe discharge of the energy reservoir can be prevented. As a result, however, the energy volume of the energy reservoir available for the contribution of the at least one electrical machine for implementation of the target value for the output variable cannot always be fully utilized.

In embodiments of the present invention, the predefined time is predefined as a function of an energy withdrawn from an energy reservoir. Better utilization of the energy volume of the energy reservoir available for the contribution of the at least one electrical machine to implementation of the target value for the output variable is thus possible.

In embodiments of the present invention, precise utilization of the energy volume of the energy reservoir available for the contribution of the at least one electrical machine to implementation of the target value for the output variable can be achieved if the predefined time is selected so that during the predefined time, no more than a predefined energy volume is withdrawn from the energy reservoir. The predefined energy volume can be, for example, suitably applied on a test stand in such a way that the energy volume of the energy reservoir available for the contribution of the at least one electrical machine to implementation of the target value for the output variable can be completely utilized without needing to accept an undesirably severe discharge of the energy reservoir. For example, a result is that an undesirably severe discharge of the energy reservoir is reliably prevented, and an energy volume of the energy reservoir available for the contribution of the at least one electrical machine to implementation of the target value for the output variable is completely utilized.

In embodiments of the present invention, in the case in which the time for which the target value is predefined expires earlier than the predefined time, the portion of the predefined energy volume not used for implementation of the target value for the output variable is used for implementation of a subsequently predefined further target value for the output variable. Accordingly, the available energy volume of the energy reservoir may be distributed over multiple different operations for implementation of a target value for the output variable by way of the contribution of the at least one electrical machine. The energy volume of the energy reservoir available for the contribution of the at least one electrical machine to implementation of the target value for the output variable can thus be completely utilized even if it is not completely required for implementation of the aforesaid target value. In embodiments of the present invention, the energy volume withdrawable from the energy reservoir per unit time is limited to a predefined value. This makes it possible to limit the number of operations that can be carried out per unit time for implementing a target value for the output variable with the aid of the contribution of the at least one electrical machine.

In embodiments of the present invention, for the case in which the time for which the target value is predefined expires later than the predefined time, after expiration of the predefined time an energy reservoir is charged to a predefined value, for example, to a predefined voltage. This ensures, for example, that the energy reservoir does not become undesirably severely discharged, and that the energy reservoir becomes recharged at the earliest possible point in time after the energy withdrawal for the contribution of the at least one electrical machine to implementation of the target value for the output variable, and is thus available once again as promptly as possible for a further operation for implementation of a further target value for the output variable.

In embodiments of the present invention, the predefined time is predefined as a function of an exerted angular momentum of the drive unit. This allows, for example, the predefined time to be ascertained with less complexity than as a function of the energy withdrawn from the energy reservoir.

In embodiments of the present invention, the predefined time is selected so that no more than a predefined angular momentum is exerted during the predefined time. As a result, the same motion effect, in the form of a consistently identical acceleration of the vehicle driven by the drive train, is always achieved when the predefined time is reached.

### BRIEF DESCRIPTION OF THE DRAWINGS

Exemplifying embodiments of the invention are depicted in the drawings and explained further in the description below.

FIG. 1 is a schematic view of a drive unit.

FIG. 2 is a functional diagram of an embodiment according to the present invention.

FIG. 3 is a flowchart of an exemplifying execution sequence of an embodiment according to the present invention.

FIG. 4 is a diagram illustrating a determination of a predefined maximum time available for implementation of a target value for an output variable of the drive unit with the aid of a contribution of at least one electrical machine in an embodiment according to the present invention.

### DETAILED DESCRIPTION

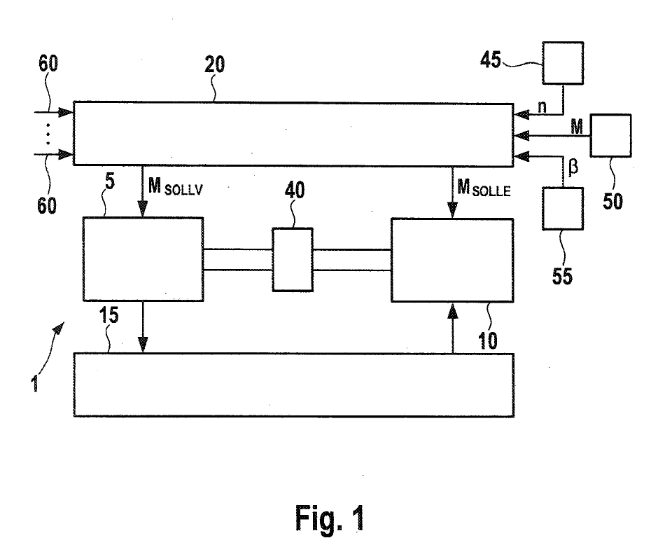

FIG. 1 shows a drive unit 1 having a combustion engine 5 and an electrical machine 10, which are coupled to one another via a mechanical coupling 40 and enable, for example, a so-called hybrid drive system. In this context, an energy reservoir 15 in the form of, for example, a battery is charged by combustion engine 5 in certain operating states, and supplies electrical machine 10 with electrical energy. Drive unit 1 drives, for example, a vehicle. Control of the drive unit is accomplished by way of an engine controller 20. A rotation speed n of a crankshaft of drive unit 1, the crankshaft being driven by the combustion engine and/or by electrical machine 10, is delivered to engine controller 20 from a rotation speed sensor 45. A torque ascertaining unit 50 senses, with the aid of suitable sensor technology or by modeling based on operating variables of electrical machine 10, in a manner known to one skilled in the art, the torque M generated by electrical machine 10 and outputted via coupling 40. An accelerator pedal module 55 senses, with the aid of suitable sensor technology and in a manner known to one skilled in the art, the degree of actuation, or accelerator pedal angle β, of an accelerator pedal. The ascertained rotation speed n, ascertained torque M, and ascertained accelerator pedal angle β are delivered to controller 20 in the form of time-continuous signals. In an embodiment, further input variables 60 are additionally delivered to engine controller 20 as applicable.

In embodiments of the present invention, as a function of the variables that are delivered, engine controller 20 ascertains a target torque M_{SOLLV} that is to be implemented by combustion engine 5 and a target torque M_{SOLLE} that is to be implemented by electrical machine 10.

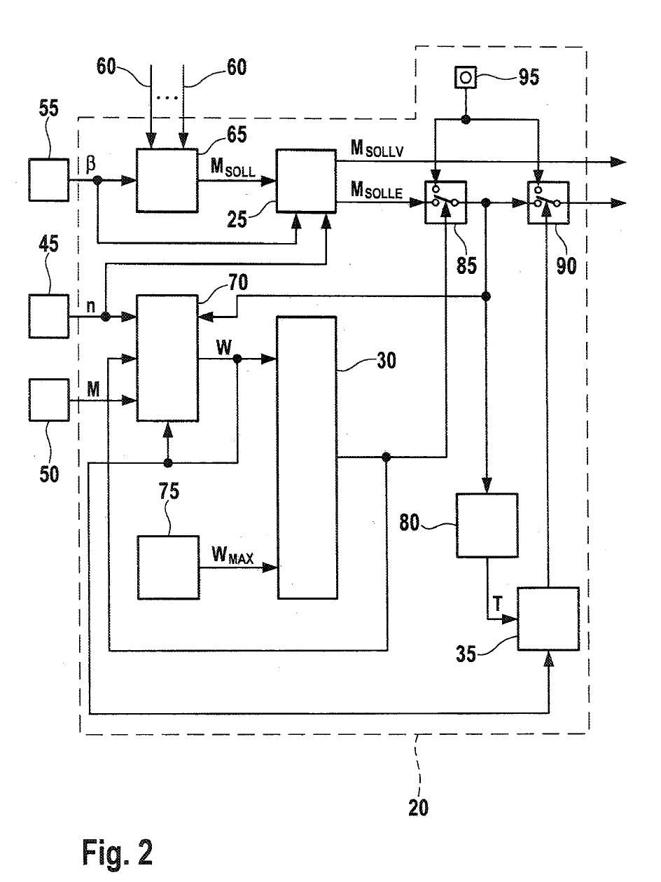

In FIG. 2, an example embodiment according to the present invention is provided in which the target torque M_{SOLLV} for combustion engine 5 and target torque M_{SOLLE} for electrical machine 10 are ascertained by engine controller 20. Engine controller 20 encompasses an evaluation unit 65 that has accelerator pedal angle β delivered to it from accelerator pedal module 55. In an embodiment, further input variables 60 are also delivered to evaluation unit 65. These can be torque requests of further control systems, for example, an automatic slip control system, a vehicle dynamics control system, a vehicle speed control system, an idle controller, a jerk-prevention system, etc. For example, in the case of the idle controller and jerk-prevention system, the corresponding torque requests are also, for example, generated inside engine controller 20 in a manner known to one skilled in the art. From accelerator pedal angle β, evaluation unit 65 ascertains a corresponding driver's torque input in a manner known to one skilled in the art. Evaluation unit 65 ascertains, from the driver's torque input and from the torque requests in accordance with the further input variables 60, in a manner known to one skilled in the art, for example, by suitable coordination, a resulting target torque M_{SOLL} to be implemented, and forwards it to an implementation unit 25. In an embodiment, the further input variables are also delivered to engine controller 20, and to evaluation unit 65 therein, as time-continuous signals in each case. Implementation unit 25 ascertains in a manner known to one skilled in the art, as a function of accelerator pedal angle β and rotation speed n and, if applicable, as a function of further operating variables of combustion engine 5 that are not depicted in FIG. 2, the torque that can at present be established by combustion engine 5. If, for example, that torque is greater than or equal to the resulting target torque M_{SOLL}, implementation unit 25 then predetermines the resulting target torque M_{SOLL} as target torque M_{SOLLV} for combustion engine 5, and predefines a value of zero for target torque M_{SOLLE} for the electrical machine. If, for example, the torque that can at present be established by combustion engine 5 is less than M_{SOLL}, then the maximum torque that can at present be established by combustion engine 5 is predefined by implementation unit 25 as target torque M_{SOLLV} for combustion engine, and the resulting target torque M_{SOLL} minus the maximum torque that can at present be established by combustion engine 5 is predefined as target torque M_{SOLLE} for electrical machine 10. Target torque M_{SOLLV} for combustion engine 5 is then implemented in a manner known to one skilled in the art, for example, using suitable control variables of combustion engine such as, for example, the air delivery, ignition angle, and/or injection quantity of combustion engine 5, whereas electrical machine likewise implements target torque M_{SOLLE} in the manner known, for example, from German patent reference no. DE 10 2004 044 507 A1. In an embodiment, predefined variable M_{SOLLE} for the torque of electrical machine 10 is, however, delivered via a first controlled switch 85 and a second controlled switch 90.

In embodiments of the present invention, motor controller 20 includes an ascertaining unit 70 that, for example, according to a first embodiment as shown in FIG. 2, has delivered to it the rotation speed n of the crankshaft from rotation speed sensor 45, and the ascertained instantaneous torque, or actual torque, of electrical machine 10 from torque ascertaining unit 50. Ascertaining unit 70 ascertains the energy volume withdrawn from energy reservoir 15. For this purpose, for example, ascertaining unit 70 also has delivered to it the output signal of first controlled switch 85. The output of first controlled switch 85 is acted upon, depending on the switch position of first controlled switch 85, by either target value M_{SOLLE} of implementation unit 25 or the value zero from a zero value memory 95. For example, as soon as a signal differing from zero is present at the output of first controlled switch 85, ascertaining unit 70 calculates the energy volume W withdrawn from energy reservoir 15, as follows:

W=M*2n*n*t (1),

in which t is the time that has elapsed since detection of an output signal differing from zero of first controlled switch 85. Energy volume W is ascertained as a time-continuous signal as a function of the elapsed time t, torque M, and rotation speed n, and is forwarded by ascertaining unit 70 to a first limiting unit 30. Also delivered to first limiting unit 30, from a definition memory 75, is a predefined energy volume W_{MAX}. This can be applied, for example, on a test stand, in such a way that it corresponds to that energy volume which may be withdrawn, at maximum, from energy reservoir 15 charged to a predefined voltage or charge value in order reliably to prevent an undesirably severe discharge of energy reservoir 15. For example, first limiting unit 30 compares the ascertained energy volume W instantaneously withdrawn from the energy reservoir 15 with the predefined energy volume W_{MAX}. If first limiting unit 30 determines that W<W_{MAX}, it then authorizes first controlled switch 85 to connect its output to that output of implementation unit 25 at which signal M_{SOLLE}, i.e., the target value of the torque of electrical machine 10, is present. Otherwise, first limiting unit 30 authorizes first controlled switch 85 to connect its output to the output of zero value memory 95. This, for example, reliably prevents an undesirably severe discharge of energy reservoir 15, and ensures that the maximum possible energy volume W_{MAX} can be made available for implementation of the resulting target torque M_{SOLL}. In an embodiment, as illustrated in FIG. 2, the output signal of ascertaining unit 70 is delivered back to ascertaining unit 70, in the form of the ascertained energy volume W withdrawn from energy reservoir 15, as an input variable. In addition, with this optional embodiment according to FIG. 2, the output of first limiting unit 30 is also delivered to ascertaining unit 70. Provision is made in this context, for example, so that the output signal of first limiting unit 30 is reset as long as W<W_{MAX}, and otherwise the output signal of first limiting unit 30 is set. In an embodiment, if the output signal of first limiting unit 30 is reset, then as soon as first limiting unit 30 once again receives the zero signal from the output of first controlled switch 85, continuous ascertaining of the energy volume W withdrawn from energy reservoir 15 is halted, and the value then present is temporarily stored in ascertaining unit 70, as value W_{z}, as the energy volume so far withdrawn from energy reservoir 15. In this case, the target torque M_{SOLLE} for electrical machine 10, predefined by implementation unit 25, has once again reached a value of zero with no need for the available energy volume W_{MAX} of energy reservoir 10 to have been completely exhausted by electrical machine 10. In an embodiment, the remaining quantity of energy volume W_{MA}X−W_{Z} can then be made available for the case of a subsequent new request M_{SOLLE}>0 for the target torque of electrical machine 10. The formula for ascertaining the energy volume withdrawn from energy reservoir 15 can thus be stated more precisely as:

W=W_{z}+M*2*π*n*t (2).

As soon as ascertaining unit 70 receives the setting signal from the output of first limiting unit 30, W_{z} is set to zero. The calculation process for W according to equation (2) is always restarted from t=0 as soon as, starting from a value of zero, a value greater than zero is detected at the output of first controlled switch 85.

In embodiments, the output of first controlled switch 85 is also delivered to a timing element 80 that is started as soon as, proceeding from a value of zero at the output of first controlled switch 85, a value greater than zero is detected. Timing element 80 measures the instantaneous time T since the last occurrence of a zero value at the output of first controlled switch 85. This time T is ascertained continuously by timing element 80 and forwarded to a second limiting unit 35 of engine controller 20. Also delivered to second limiting unit 35 is the time-continuous output signal of ascertaining unit 70, and, thus, the instantaneously ascertained energy volume W withdrawn from energy reservoir 15. Second calculation unit 35 calculates the quotient W/T and compares it with a predefined threshold value S. The predefined threshold value can be suitably applied, for example, on a test stand, in such a way that it limits to a maximum tolerated value the number of different operations for assisting the implementation of the resulting target torque M_{SOLL} by way of a target torque of electrical machine 10. This can be, for example, S=3 kJ/min. In an embodiment, as long as W/T<S, second limiting unit 35 applies control to second controlled switch 90 at the output of first controlled switch 85 in such a way that the output of first controlled switch 85 is forwarded to electrical machine 10 for implementation. Otherwise, second limiting unit 35 applies control to second controlled switch 90 in such a way that a zero value is delivered from zero value memory 95 to electrical machine 10 as a target torque to be implemented, so that in this case electrical machine 10 will make no torque contribution. In embodiments, second switch 90, together with timing element 80 and second limiting unit 35, is provided optionally, so that in the case in which second switch 90 is omitted, the output of first controlled switch 85 is delivered directly to electrical machine 10 for implementation.

In alternative embodiments, ascertaining unit 70 ascertains not, as described, the energy volume W withdrawn from energy reservoir 15 by the torque contribution of electrical machine 10, but, instead, the angular momentum H=M*t applied by electrical machine 10. Definition unit 75 then predefines a correspondingly applied maximum permissible angular momentum H_{MAX} that is compared, in first limiting unit 30, with value H from ascertaining unit 70. In an embodiment, if H≦H_{MAX}, then first controlled switch 85 has control applied to it by first limiting unit 30 in such a way that the output of first controlled switch 85 is connected to target value output M_{SOLLE} of implementation unit 25. Otherwise, i.e., if H>H_{MAX}, the output of zero value memory 95 is connected to the output of first controlled switch 85. In this way, the same motion effect, in the form of the same acceleration at the vehicle, is achieved each time H reaches H_{MAX}.

Ascertaining the angular momentum does not require that rotation speed n be delivered to ascertaining unit 70.

In alternative embodiments, it is sufficient if ascertaining unit 70 merely senses the time t since the occurrence of a value differing from zero at the output of first controlled switch 85, and if that value is compared with a maximum value T_{MAX}, predefined by definition memory 75, of first limiting unit 30. In an embodiment, the predefined maximum value T_{MAX} is suitably applied on a test stand for a time such that to the greatest extent possible, for any operation in which the resulting target torque M_{SOLL} is to be implemented by way of a torque contribution of electrical machine 10 that is greater than zero, no undesirably severe discharge of energy reservoir 15 occurs. In an embodiment, definition value H_{MAX} is suitably applied, for example, on a test stand, in such a way that to the greatest extent possible, for any operation in which a resulting target torque M_{SOLL} is to be assisted by a positive torque contribution of electrical machine 10, no undesirably severe discharge of energy reservoir 15 occurs.

In embodiments according to the present invention, the result of predefinition W_{MAX} for the energy volume withdrawable from energy reservoir 15, or of predefinition H_{MAX} for the angular momentum exerted by electrical machine 10, is thus, for each operation in which the resulting target value M_{SOLL} for the torque is to be implemented with the aid of electrical machine 10, to identify indirectly a predefined time that expires when value W reaches the predefined value W_{MAX} or when value H reaches value H_{MAX}. In such embodiments, the maximum contribution of electrical machine 10 for implementation of the resulting target value M_{SOLL} is made available for that respective predefined time. In the case of predefinition T_{MAX} this predefined time is predefined directly as a fixed value. In this context, T_{MAX} can be in the single-digit second range. T_{MAX} can be, for example, 5 seconds. In the case of predefinitions H_{MAX} or T_{MAX}, second controlled circuit switch 90, timing element 80, and second limiting unit 35 are not necessary.

According to the present invention, therefore, the contribution of electrical machine 10 to implementation of the resulting target value M_{SOLL} for the torque is reduced either upon expiration of the time for which the resulting target value M_{SOLL} is predefined, or after expiration of the predefined time, depending on which of the two times expires earlier. The predefined time is determined, as described above, either directly via T_{MAX} or indirectly via Wor H_{MAX}. If the time for which the resulting target value M_{SOLL} is predefined expires first, the contribution of electrical machine 10 is then reduced with the resetting to zero of target value M_{SOLLE} by implementation unit 25. If, on the other hand, the predefined time expires earlier than the time for which the resulting target value M_{SOLL} is predefined, then the contribution of electrical machine 10 to implementation of the resulting target value M_{SOLL} is reduced by way of the above-described application of control to first controlled switch 85 when predefined time T_{MAX} is reached, or when the predefined value W_{MAX} for the energy volume withdrawn or H_{MAX} for the exerted angular moment is reached. In the latter case, in which the time for which the resulting target value M_{SOLL} is predefined expires later than the predefined time, after expiration of the predefined time the energy reservoir 15 is charged by combustion engine 5 to a predefined value, for example, in the form of a predefined voltage or a predefined charge. Provision can be made in this context that, in order to connect the output of implementation unit 25 to target value M_{SOLLE} for the torque to be exerted by electrical machine 10, first controlled switch 85 (and if applicable second controlled switch 90) is connected to electrical machine 10, in order to enable another contribution by electrical machine 10 to implementation of the resulting target torque M_{SOLL}, no earlier than the time at which energy reservoir 15 has recharged to the predefined value, for example, the predefined voltage or predefined charge. In an embodiment, for this purpose, the instantaneous charge or instantaneous voltage of energy reservoir 15 is compared with the predefined charge or with the predefined voltage, and the above-described circuit made up of first controlled switch 85 (and, if applicable, second controlled switch 90) is authorized to enable the contribution of electrical machine 10 for implementation of the resulting target torque M_{SOLL} as soon as the instantaneous charge of energy reservoir 15 reaches the predefined charge or as soon as the instantaneous voltage of energy reservoir 15 reaches the predefined voltage. The predefined charge or predefined voltage of energy reservoir 15 can be suitably applied, for example on a test stand, and is selected so that an energy withdrawal from energy reservoir 15 of the magnitude of W_{MAX}, or exertion of an angular momentum by electrical machine 10 of the magnitude of H_{MAX}, or an energy withdrawal from energy reservoir 15 for the predefined time T_{MAX}, does not result in an undesirably severe discharge of energy reservoir 15.

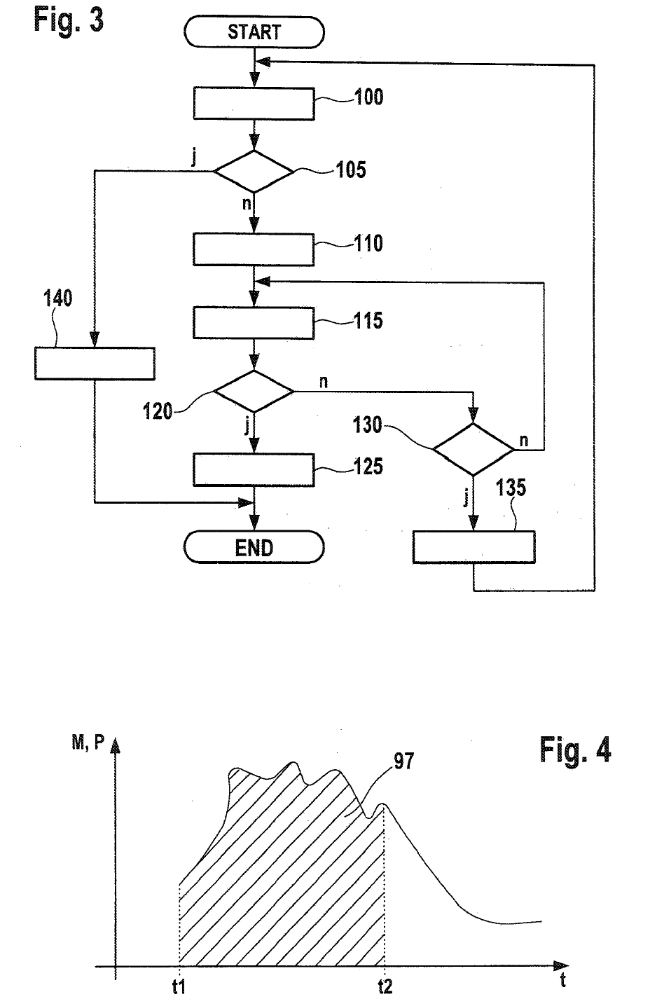

FIG. 3 is a flowchart of an exemplifying execution sequence for an embodiments according to the present invention. After the program starts, the resulting target torque M_{SOLL} is ascertained at a time 100 by evaluation unit 65. Execution then branches to a program point 105.

At program point 105, implementation unit 25 checks whether the resulting target torque M_{SOLL} can be established by combustion engine 5 alone. If so, at a program point 140 implementation unit 25 sets M_{SOLLV}=M_{SOLL} and M_{SOLLE}=0, and execution then leaves the program. If implementation unit 25 determines that the resulting target torque M_{SOLL} cannot be established by combustion engine 5 alone, execution then branches to a program point 110.

At program point 110, implementation unit 25 sets target torque M_{SOLLV} for combustion engine 5 to the maximum torque that can be established by combustion motor 5, and sets target torque M_{SOLLE} for electrical machine 10 to the resulting target torque M_{SOLL} minus the maximum torque that can be established by combustion motor 5. Execution then branches to a program point 115.

At program point 115, ascertaining unit 70 ascertains, in the manner described above, the value W for energy quantity W withdrawn from energy reservoir 15 up to the present point in time. Execution then branches to a program point 120.

At program point 120, first limiting unit 30 checks whether W >W_{MAX}. If so, execution branches to a program point 125. Otherwise execution branches to a program point 130.

At program point 125, the output signal of first limiting unit 30 is set, and first controlled switch 85 is authorized to connect the value 0 from zero value memory 95 to electrical machine 10. Energy reservoir 15 is then recharged by combustion engine 5, as soon as and to the point allowed by the resulting target torque M_{SOLL} to be implemented, until a predefined voltage or a predefined charge is reached. Execution then leaves the program.

At program point 130, second limiting unit 35 checks whether W/T is greater than threshold value S predefined therefor. If so, execution branches to a program point 135; otherwise execution branches back to program point 115, and a new instantaneous value for the withdrawn energy volume W is ascertained.

At program point 135, second limiting unit 35 authorizes second controlled switch 90, for a predefined time, to connect the value 0 from zero value memory 95 to electrical machine 10, and thus to interrupt the contribution of electrical machine 10 to implementation of the resulting target value M_{SOLL}. Execution then branches back to program point 100 in order to ascertain a new resulting target value M_{SOLL}. The predefined time for switching over second controlled switch 90 for connecting the value 0 from zero value memory 95 to electrical machine 10 can be suitably applied, for example, on a test stand, in such a way as to ensure that a desired maximum energy volume per unit time can be withdrawn from energy reservoir 15.

The value W is ascertained at program point 115 in accordance with equation (2).

In embodiments of the present invention, instead of ascertaining the energy volume withdrawn from energy reservoir 15 and comparing it with W_{MAX} at program points 115 and 120, it is also possible, as described, to ascertain the angular momentum H exerted by electrical machine 10 and compare it with H_{MAX}, or simply to ascertain time T and compare it with the predefined time T_{MAX}. In both of the latter cases, program points 130 and 135 are then not necessary, so that the No branch from program point 120 leads directly to program point 100. Optionally, program points 130 and 135 can also be dispensed with in the context of ascertaining the withdrawn energy volume W and comparing it with W_{MAX}, and the No branch from program point 120 can branch back directly to program point 110. In this embodiment, timing element 80, second limiting unit 35, and second controlled switch 90 are not necessary.

FIG. 4 illustrates, with reference to a time diagram, an embodiment of ascertaining energy volume W withdrawn from energy reservoir 15 or the angular momentum H exerted by electrical machine 10. FIG. 4, for example, shows the profile over time t of the torque M exerted by electric motor 10 or the power P exerted by electric motor 10. From a first point in time t₁ to a subsequent second point in time t₂, electrical machine 10 is intended to make a contribution to implementation of the resulting target value M_{SOLL}. The energy volume W withdrawn from the energy reservoir between first point in time t₁ and second point in time t₂ can thus be ascertained by integrating the curve for power P exerted by electrical machine 10 over time t between first point in time t₁ and second point in time t₂. The energy volume withdrawn from energy reservoir 15 between first point in time t₁ and second point in time t₂ is then obtained as the area under the curve for power P over time t between first point in time t₁ and second point in time t₂, and is depicted in FIG. 4 with hatching and labeled with the reference character 97. If what is being considered, instead of the change in power P over time t, is the change in torque M exerted by electrical machine 10 over time t, then area 97 depicted with hatching in FIG. 4 corresponds in this case to the angular momentum H exerted by electrical machine 10. Second point in time t₂ is either the point in time at which predefinition of the resulting target value M_{SOLL} was terminated or, as in FIG. 4 on the basis of the requested torque contribution of electrical machine 10 (indicated even after second point in time t₂), the point in time at which the predefined time expires, depending on which of the two times expires first. What therefore results in very general form, proceeding from equation (2) for ascertaining by way of ascertaining unit 70 the energy volume withdrawn from energy reservoir 15, is:

$$W = {W}_{z} + {\int }_{{t}_{1}}^{{t}_{2}} M ⋆ 2 ⋆ n ⋆ π \cdot d t . \qquad ( 3 )$$

What results correspondingly for ascertaining by way of ascertaining by way of ascertaining unit 70 the angular momentum H exerted by electrical machine 10 is, in general form:

$$H = {\int }_{{t}_{1}}^{{t}_{2}} M ⋆ d t , \qquad ( 4 )$$

in which t₁ is the point in time at which the torque request for electrical machine 10, in the form of the resulting target value M_{SOLL} and thus the torque request M_{SOLLE}, occurs for the first time.

In embodiments, the above-described assistance of electrical machine 10 by implementation of the resulting target value M_{SOLL} is also referred to as a “boost” and can be used, for example, to compensate for so-called “turbo lag” in the case in which combustion engine 5 is operated with a turbocharger, or to enhance driving enjoyment (more performance thanks to more torque). This boost operating mode deviates from the usual charging strategy when a torque request exists, in which energy reservoir 15 is to be recharged by the operation of combustion engine 5 to a predefined voltage or a predefined charge, and energy is instead withdrawn from energy reservoir 15.

In embodiments in which the energy volume W withdrawn from energy reservoir 15 for a boost operation has remained lower than W_{MAX} the W_{z} then calculated can be reduced to the extent that the energy reservoir has been recharged until the next boost operation. It is possible, for example, to apply a characteristic curve that allocates a value for W_{z} to each instantaneous voltage of energy reservoir 15 or to each instantaneous charge of energy reservoir 15, so that with the aid of this characteristic curve, the respectively associated value W_{z} for the energy volume consumed is updated in ascertaining unit 70 for the respective instantaneous value of the voltage or charge of energy reservoir 15 after a boost operation. When the predefined voltage or charge of energy reservoir 15 is reached, W_{z} becomes zero.

1-11. (canceled)

12. A method for operating a drive unit, comprising:
providing at least one combustion engine;
providing at least one electrical machine mechanically coupled to the at least one combustion engine;
implementing a target value for an output variable of the drive unit by the at least one combustion engine and the at least one electrical machine,
wherein the contribution of the at least one electrical machine to implementation of the target value for the output variable is made available at most for a predefined time.

13. The method as recited in claim 12, further comprising:
reducing the contribution of the at least one electrical machine to implementation of the target value for the output variable either upon expiration of the time for which the target value is predefined or after expiration of the predefined time, depending on which of the time and predefined time expires earlier.

14. The method as recited in claim 12, wherein the predefined time is predefined as a fixed value.

15. The method as recited in claim 12, wherein the predefined time is predefined as a function of an energy withdrawn from an energy reservoir.

16. The method as recited in claim 15, wherein the predefined time is selected so that during the predefined time, no more than a predefined energy volume is withdrawn from the energy reservoir.

17. The method as recited in claim 13, wherein the predefined time is selected so that during the predefined time, no more than a predefined energy volume is withdrawn from the energy reservoir, and wherein in the case in which the time for which the target value is predefined expires earlier than the predefined time, the portion of the predefined energy volume not used for implementation of the target value for the output variable is used for implementation of a subsequently predefined further target value for the output variable.

18. The method as recited in claim 15, wherein the energy volume withdrawable from the energy reservoir per unit time is limited to a predefined value.

19. The method as recited in claim 12, wherein for the case in which the time for which the target value is predefined expires later than the predefined time, after expiration of the predefined time an energy reservoir is charged to a predefined value.

20. The method as recited in claim 12, wherein the predefined time is predefined as a function of an exerted angular momentum of the drive unit.

21. The method as recited in claim 20, wherein the predefined time is selected so that no more than a predefined angular momentum is exerted during the predefined time.

22. An apparatus for operating a drive unit, comprising:
at least one combustion engine;
at least one electrical machine mechanically coupled to the at least one combustion engine;
means that authorize an implementation of a target value for an output variable of the drive unit by way of the at least one combustion engine and the at least one electrical machine; and
limiting means which make the contribution of the at least one electrical machine to implementation of the target value for the output variable available at most for a predefined time.

23. The method as recited in claim 17, wherein the energy volume withdrawable from the energy reservoir per unit time is limited to a predefined value.

24. The method as recited in claim 19, wherein the predefined value is a predefined voltage.
